(19) United States
(12) Patent Application Publication
(10) Pub. No.: US 2009/0210345 A1
(43) Pub. Date: Aug. 20, 2009

(54) Method for editing a ticket of limited duration, system therefore and resulting ticket

(76) Inventors: Damien Mandy, Fontain (FR); Thierry Mougin, Saint Vit (FR)

Correspondence Address: SOFER & HAROUN LLP., 317 MADISON AVENUE, SUITE 910, NEW YORK, NY, 10017, US

(21) Appl. No.: 12/315,257

(22) Filed: Dec. 1, 2008

Related U.S. Application Data
(62) Division of application No. 10/496,174, filed on Aug. 9, 2004, now abandoned.

(30) Foreign Application Priority Data
Nov. 19, 2001 (FR) 01 15022
Oct. 30, 2002 (FR) PCT/FR02/03730

(51) Int. Cl. H04L 9/28; G06Q 50/00; G06Q 30/00

(52) U.S. Cl. 705/50; 705/13

(57) ABSTRACT

The invention concerns a method for editing a ticket providing access to a product or a service with specific duration and or expiry date, characterised in that it comprises a step of recording (EIA) on the ticket an authenticating information encrypted at least partly in accordance with a specific encryption law.

### RELATED APPLICATION

This application is a divisional application of U.S. patent application Ser. No. 10/496,174 filed on Oct. 30, 2002, which is a National Phase application of PCT/FR02/02730, which claims priority to French Patent Application No. 01/15022, filed on Nov. 19, 2001, the entirety of which are incorporated by reference.

### FIELD OF THE INVENTION

The invention concerns a method for editing a ticket providing access to a product or a service with specific duration and or expiry date.

The invention has a particularly advantageous application in the field of tickets used during a certain period of time and in particular, parking tickets.

### BACKGROUND

In a well-known manner, to have the right to use a parking space, a motorist must go to a parking meter immediately after parking his vehicle, and insert the amount of money that corresponds to the duration he wishes to leave his vehicle in the parking space.

In exchange for the payment, the parking meter prints on a ticket the date and time of the end of paid parking, thus the charge paid be the motorist. The user then places the ticket on the inside of the windscreen of his vehicle in the event of a visual verification by authorised persons.

However, there are fraudulent possibilities that consist in, for example, printing false tickets on stolen parking meters.

Current parking meters only print details regarding the end of paid parking. Thus, possible fraud is simple and undetectable.

The printing of an identification code on each ticket has already been proposed. However, checking could prove to be complicated if verification of the validity of the ticket is carried out by a ticket inspector. Indeed, the visual identification of a code comprising a large number of digits is not easy.

### OBJECTS AND SUMMARY

The purpose of the invention is to propose a method for editing tickets that allows the printing of authentication information which is easily identifiable by a ticket inspector and which is difficult to fraudulently reproduce.

For this reason, the invention proposes a method, of the aforementioned type, characterised in that it comprises a step of recording on the ticket the encryption authentication information at least partly in compliance with a specific encryption law.

According to other characteristics of the invention:
the step of recording the authentication information comprises a step of generating a first part of the encrypted authentication information;
the step of generating the first part of the authentication information consists in generating a code according to a parameter relative to the validity of the ticket, notably a validity start date of the ticket, according to a specific key algorithm;
the method comprises a step of periodic configuring of the encrypting key modifications at specific times;
the step of generating the first part of the authentication information consists in generating a graphic device whose form and/or colour is specific according to the parameter relative to the validity of the ticket;
the step of configuring comprises a step of defining the relation between the graphic device and the parameter relative to the validity of the ticket;
the step of recording the authentication information comprises a step of generating a second part of the authentication information which is an identification number of the ticket;
the step of generating the second part of the authentication information is an increment starting from the editing of the previous ticket;
the step of recording the authentication information comprises a step of generating a third part of the authentication information on the basis of a specific signature function, according to the first part and/or the second part of the authentication information;
the method comprises at least one controllable step of recording the authentication information on the ticket;
the step of recording consists in the printing of the authentication information on a ticket.

The invention also proposes a system of editing a ticket, a type that implements a method that complies with the instructions of the invention, characterised in that it comprises at least a device of recording at least partly the encrypted authentication information.

According to other characteristics of the system:
the means of editing a ticket comprises a device of recording at least partly the encrypted authentication information;
the device of recording authentication information comprises a device of defining a first part of the encrypted authentication information, a device of defining a second part of the authentication information by generating a unique identification number of the ticket, and a device of defining a third part of the authentication information by encoding the first part of the authentication information with the second part of the authentication information;
the device of generating an identification number is linked to a system of transaction authorisation and generating of a transaction identifier, which is independent of the system;
the device of editing a ticket comprises a system of recording the authentication information on the ticket;
the recording system is a system of printing tickets.

The invention further proposes a ticket produced and used by a method and generated by a system that complies with the instructions of the invention, characterised in that at least partly the encrypted authentication information is printed on at least one side of the ticket.

According to other characteristics of the ticket:
a first part of the authentication information is encrypted according to a parameter relative to the validity of the ticket according to a specific key algorithm;
the first part of the authentication information is a graphic device whose form and/or colour is specified according to the parameter relative to the validity of the ticket;
a second part of the authentication information is an identification number of the ticket;
the identification number of the ticket is an increment number specified by the device of defining the second part of the authentication information;
the identification number of the ticket is a transaction number specified by an external system of transaction authentication;
a third part of the authentication information is specified by combining the first part and the second part according to a specific signature function.

### BRIEF DESCRIPTION OF THE DRAWINGS

Other characteristics and advantages of the invention will appear upon reading the detailed description that follows and to facilitate understanding we refer to the annexed figures among which:

FIG. 1 is a diagram which diagrammatically represents the overall operating of the method in compliance with the invention;

FIG. 2 is a diagram which diagrammatically represents the step of defining the length of time, in compliance with the invention;

FIG. 3 is a diagram which diagrammatically represents the step of editing the authentication information, in compliance with the invention;

FIG. 4 is a diagram which diagrammatically represents the step of controlling, in compliance with the invention;

FIG. 5 diagrammatically represents a system of controlling, in compliance with the invention;

FIG. 6 diagrammatically represents a means of editing the support, in compliance with the invention;

FIG. 7 diagrammatically represents a system of controlling when the latter is an automaton, in compliance with the invention;

FIG. 8 diagrammatically represents a ticket in compliance with the invention.

### DETAILED DESCRIPTION

We will now describe a preferred operating mode of the method in compliance with the instructions of the invention.

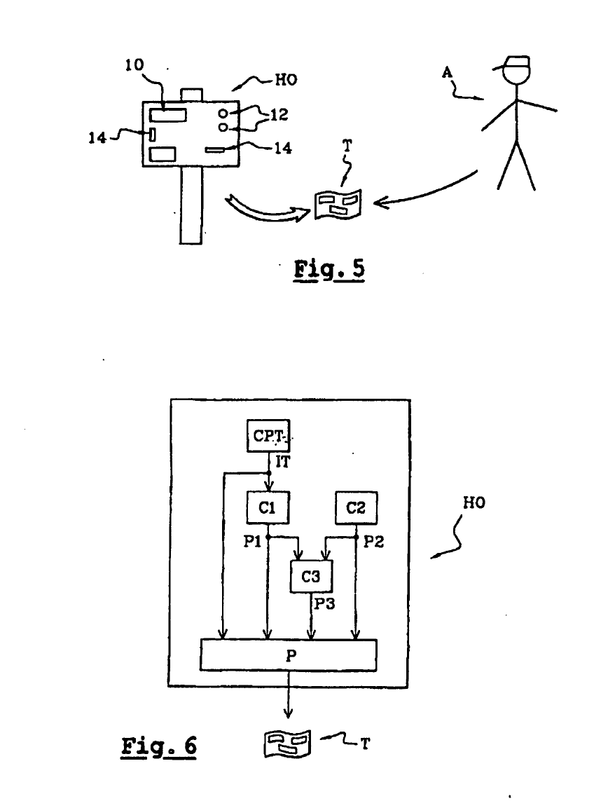

When the user wishes to use a paid parking space, he purchases a ticket such as a ticket “T” from a parking meter “HO”, as illustrated in FIG. 5, giving him the right to use a parking space.

The ticket “T” defines the length of time and/or the date up to which the user can use the parking space.

These lengths of time are specified according to an amount of money “SP” inserted into the parking meter “HO”, during the purchase transaction.

To save paying for this ticket “T”, some fraudulent operators are enticed to print false tickets allowing them to use a parking space without having to spend any money.

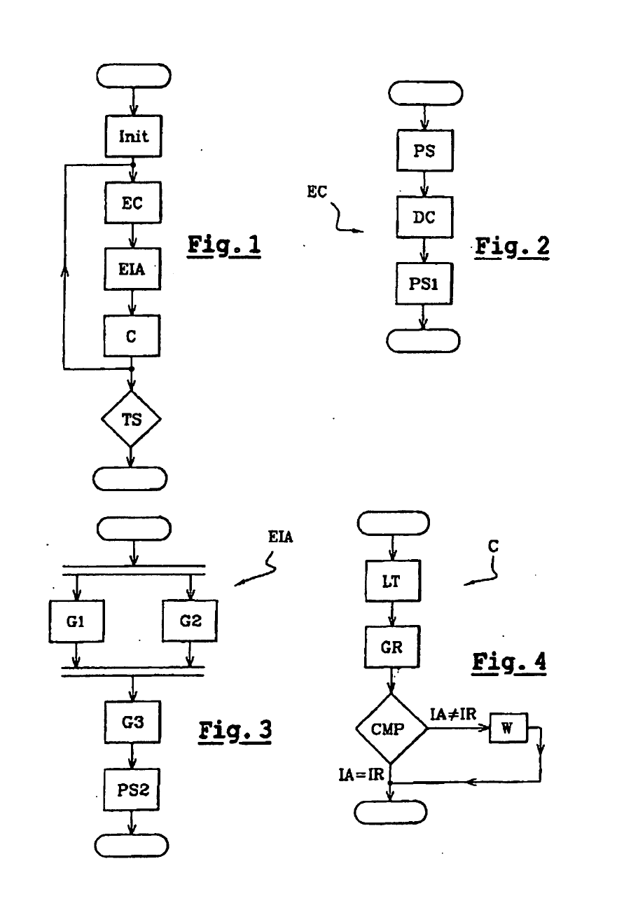

To restrict the risk of printing false tickets, the invention proposes a method for editing a ticket “T”, as represented in FIG. 1, which comprises:
a step of defining “DC” the length of time of the validity of the ticket “T”;
a step of recording “EIA” the authentication information “IA” on the ticket “T”; and
a step of controlling “C” the authentication information “IA” which is edited on the ticket “T”.

Upon completion of the step of recording “EIA” the authentication information “IA”, the user recuperates the printed ticket “T”, and places it on the inside of the windscreen of his vehicle in the event of a possible verification “C” of the ticket “T”, and notably of the authentication information “IA”. This step of controlling “C” can take place at any time whilst the parking space is in use. It is for this reason that the ticket “T” must remain behind the windscreen for the full length of time. The step of controlling “C” can also be carried out after the parking duration, during, for example, the handling of claims.

As represented in FIG. 2, the step of defining “DC” the length of time of validity of the ticket “T” starts with a step of paying “PS” an amount of money “SP”. The step of paying “PS” is followed by a step of defining “DC” the length of time of validity of the ticket “T”.

This step of defining “DC” the length of time of validity of the ticket “T” consists in defining the parking start and end times calculated according to the amount of money paid “SP”, that being the parameters “IT” relative to the validity of the ticket “T”.

The end of parking time is generally equal to the time at which the user makes the payment increased by the length of time calculated according to the amount of money paid “SP”.

The step of defining “DC” the length of time of validity of the ticket “T” is followed by a step of printing “PS1” the parameters “IT” relative to the validity of the ticket “T”.

The step of recording “EIA” the authentication information “IA” consists in generating authentication information “IA”. This authentication information “IA” is specified according to at least one parameter “IT” relative to the validity of the ticket “T”, and at least one part of the authentication information “IA” is encrypted.

As represented in FIG. 3, the step of recording “EIA” the authentication information “IA” comprises a step of generating “G1” a first part “P1” of the authentication information “IA”.

The step of generating “G1” the first part “P1” consists in encrypting at least one of the parameters “IT” relative to the validity of the ticket “T” to obtain an easy to identify code, that being two or three numbers or a drawing that is easily identifiable during the ticket inspection “T”.

The first part “P1” is specified from the end of parking time, or “numeric day”. It is possible to specify the first part “P1” by encrypting other parameters “IT” relative to the validity of the ticket “T” or the start of parking day. It is also possible to encrypt several of these pieces of information together.

According to a preferred embodiment of the invention, the first part “P” is encrypted according to a key algorithm.

The key is modified by reprogramming the parking meter “HO”, the reprogramming can be done in situ by a maintainer, or via downloading from the inspection authority of the parking meters when the latter are linked to a central monitoring station.

This step of modifying the key is part of an initial step of configuring “INIT” the parking meter “HO”. This step is performed at the beginning of the method, prior to any transactions, thus, several consecutive transactions can take place without the need for changing the key.

Thus, as represented in FIG. 1, the method comprises a loop corresponding to a transaction, and the beginning of this loop is located after the step of configuring “INIT”. The loop also comprises a final step of testing “TS” which corresponds to the immobilising of the parking meter “HO”, for example for it to be serviced.

As the key is modified at specific times by the inspection authority, it is not possible to know precisely what the value of the key will be at any given time. This renders it difficult for fraudulent operators who could try to know the key, for example from the tickets issued by the parking meters, and use the key to print false tickets.

Moreover, to restrict fraudulent printing of a ticket “T” from a stolen parking meter “HO”, the key can be modified for example every fortnight or after every 1,000 tickets. Thus, a stolen parking meter “HO” can only produce for a maximum of fifteen days or up to 1,000 tickets.

The first part “P1” can also be presented in the form of a drawing whose form and/or colour is specific according to a parameter relative to the validity of the ticket “T”.

The periodic reprogramming of the parking meter “HO” is thus the definition of the variation law of the form and/or colour of the first part “P1” according to one of the parameters “IT” relative to the validity of the ticket “T”.

The step of recording “EIA” the authentication information “IA” comprises a step of generating “G2” a second part “P2” of the authentication information “IA”.

This second part “P2” is a unique identification number of the ticket “T”.

This identification number is an increment number specified from the previous transaction, the step of generating “G2” the second part is thus a step of incrementing.

According to an alternative of the invention, the second part “P2” is an authorisation number of the payment transaction. This authorization number is created when the payment is made using, for example, a bank card or a GSM telephone.

Indeed, during such a payment, the purchase transaction is authorised by a system out with the inspection authority of the parking meters. A transaction number is then attributed so as to be used later on, notably by banking institutions at the time of compensating or invoicing.

The step of recording “EIA” the authentication information “IA” comprises a step of generating “G3” a third part “P3” of the authentication information “IA”.

This third part “P3” consist in a signature of the parking meter “HO”, this signature being specified from a specific signature function specific to the parking meter “HO”. The third part “P3” is specified according to the first part “P1” and according to the second part “P2”. This third part “P3” allows to ensure in an unavoidable manner the validity of a ticket.

This third part “P3” allows to increase the difficulty in forging a ticket “T”, notably by recopying the first part “P1” from a previously printed ticket and by generating a coherent second part “P2”.

The step of recording “EIA” the authentication information “IA” comprises a final step of printing “PS2” the authentication information “IA” on the ticket.

According to a non-represented embodiment of the invention, the two steps of printing “PS1” and “PS2” are simultaneous.

The method further comprises a step of controlling “C” the transaction which is of common knowledge, ensured by a ticket inspector “A” who is usually a traffic warden.

The step of controlling “C” comprises a step of reading “LT” the information printed on the ticket “T”, as represented in FIG. 4.

This step of reading “LT” firstly allows to check that the end of parking time has not been exceeded, in which case the user would be in offence. It also allows to check if the ticket “T” is legal or not.

The checking of the legality of the ticket “T” is done by comparing the authentication information “IA” with what is known as referential authentication information “IR”.

According to a preferred embodiment of the invention, the referential authentication information “IR” is the first part “P1” of the authentication information “IA”.

As the first part “P1” of the authentication information “IA” is specified according to the validity date or the issue date of the ticket “T”, it is the same for several tickets even all the tickets produced in the same day.

It is therefore easy for the ticket inspector “A” to know what the value of the referential authentication information “IR” is at the time of controlling.

According to an alternative of the invention, the controlling “C” is done on all of the authentication information “IA”.

The referential authentication information “IR” is then specified during a step of generating “GR” the referential authentication information “IR”.

This step of generating “GR” the referential authentication information “IR” can consist in reading the referential authentication information “IR” on other already printed tickets placed on the inside of other vehicles, or by printing a ticket via the parking meter.

The ticket inspector “A” can be in possession of an electronic device to generate the referential authentication information “IR”.

This electronic device can be linked to the parking meter “HO” so as to read the encoding parameters specific to the parking meter “HO”, that are the signature function, the encoding algorithm of the first part “P1”, and the key encoding algorithm. The electronic device can further comprise a device of storing “SPC” in which all the encoding parameters of each parking meter are recorded.

The referential authentication information “IR” is then generated by the electronic device once the parameters “IT” relative to the validity of the ticket “T” have been inputted, which are printed on the ticket “T”. The inputting can be manual by means of a keyboard, or automatic by means of an optical reader. The generating of the referential authentication information “IR” is done according to the same steps as the generating of the authentication information “IA”.

The generating of the referential authentication information “IR” is followed by a step of comparing “CMP” the authentication information “IA” and the referential authentication information “IR”.

If these two pieces of information are identical, this signifies that the ticket “T” is legal. If the two pieces of information are different, this signifies that there has been fraud, the step of comparing is then followed by a step of alerting “W” which can result in the delivering of a fine.

We will now describe a system of controlling the implementation of the aforementioned method.

As represented in FIG. 5, the system comprises a device of editing a ticket “T”, which is generally a parking meter “HO”, and a device of controlling the ticket “T” which is generally a ticket inspector “A”, that being a traffic warden.

The parking meter “HO” comprises devices for speaking with the user as, for example, a display device 10, operating buttons 12, notably for checking and/or cancelling the editing operation of a ticket “T”, and means of payment.

As represented in FIG. 6, the parking meter “HO” further comprises a device of editing “CPT” the parameters “IT” relative to the validity of the ticket “T”, a device of editing the authentication information “IA”, and a device of printing “P” the parameters “IT” relative to the validity of the ticket “T” and of the authentication information “IA”.

The device of editing “CPT” the parameters “IT” relative to the validity of the ticket “T” is a calculator of the type used in common parking meters.

The device of editing the authentication information “IA” comprises three calculators “C1”, “C2” and “C3”. These calculators allow to generate the first, second and third parts “P1”, “P2” and “P3” of the authentication information “IA”.

The first calculator “C1” allows to generate the first part “P1” of the authentication information “IA” by encrypting at least one of the parameters “IT” relative to the validity of the ticket “T”.

The second calculator “C2” allows to generate the second part “P2” of the authentication information “IA” by generating an identification number. To generate the identification number, the second calculator “C2” comprises a calculation device via increments from the number of the ticket edited during the previous transaction.

According to another embodiment of the invention, the second calculator “C2” is linked to an external system of transaction authentication. This system is used when the payment is being made using a bank card or a GSM telephone.

The third calculator “C3” allows to generate a third part “P3” of the authentication information “IA” by encoding the first part “P1” of the authentication information “IA” with the second part “P2” of the authentication information “IA”.

The parking meter “HO” further comprises a device of printing “P” a ticket “T”. The device of printing “P” is linked to a device of editing “CPT” the parameters “IT” relative to the validity of the ticket “T” and to the calculators “C1”, “C2” and “C3” of the three parts of the authentication information “IA”. The device of printing “P” recuperates the information provided by the different calculators and prints them on the ticket “T”.

The device of controlling “A” the ticket, that being the traffic warden, carries out the steps of the method defined above. These steps are performed either by the warden “A” himself or via an electronic device (not represented) which he is in possession of.

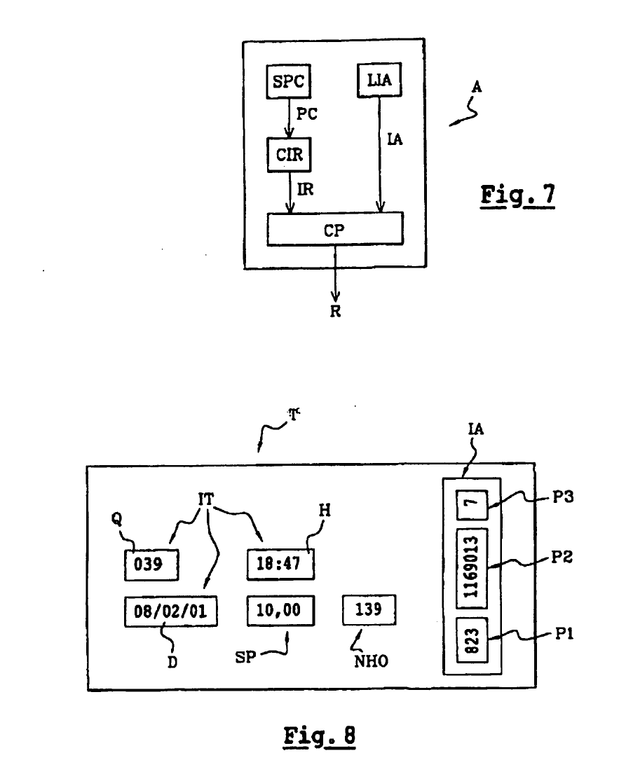

FIG. 7 represents a device of controlling “A” which the traffic warden is in possession of.

The device of controlling “A” comprises a device of inputting “LIA” the information which is edited on the ticket “T”, notably the authentication information “IA”. The device of inputting “LIA” can be, for example, an alphanumeric keyboard or an optical reader.

The device of controlling “A” further comprises a device of defining “CIR” the referential authentication information “IR”, a device of comparing “CP” allowing to check the legality of the authentication information, and a device of storing “SPC” the encoding parameters “PC”.

The device of storing “SPC” can be magazined from a central monitoring station at the start of each round. It can also be magazined during a warden's round.

When the device of storing “SPC” is magazined during the round, the encoding parameters “PC” are specified via direct interrogation of each parking meter “HO”. Thus, the electronic device comprises means of interrogating the parking meter, which comprises means of communicating with the parking meter “HO” such as a connection cable or a transmitter-receiver for remote communication.

The encoding parameters “PC” can also be specified from the information printed on other tickets issued by the same parking meter “HO”. The electronic device thus comprises means of inputting this information (not represented), these means of inputting can be the aforementioned alphanumeric keyboard or the optical reader.

The device of defining “CIR” the referential authentication information “IR” is thus a calculator which uses the encoding parameters “PC” stored in the storing device and which introduce them during the step of editing the authentication information “IA”. This allows to obtain referential authentication information “IR” which is identical to the authentication information “IA” if the ticket “T” has not been forged.

The device of comparing “CP” compares the referential authentication information “IR” with the authentication information “IA”. If these two pieces of information are identical, the device of comparing “CP” delivers a legality or authenticity identification “R” of the ticket. If these pieces of information are different, the device of comparing “CP” delivers an identification “R” signifying that the ticket has been forged, and thus liable to a fine.

FIG. 8 represents a ticket “T” issued by a parking meter “HO”. The parameters “IT” relative to the validity of the ticket “T” are indicated on the ticket “T”, such as the date “D”, the time “H” and the numeric reference “Q” of the end of parking day, as well as the amount paid “SP”.

These indications allow the traffic warden “A” to check if the parking time has not been exceeded.

The ticket “T” further comprises the reference number “NHO” of the parking meter “HO” which issued the ticket “T”, which notably allows to check that the ticket “T” was not issued by a stolen parking meter or a parking meter covering a parking zone in which the “cost” for parking is cheaper.

Finally, the ticket “T” comprises authentication information “IA” allowing to check the ticket.

The authentication information “IA”, as previously described comprises three parts “P1”, “P2” and “P3”, and at least one of these parts is encrypted.

As represented in FIG. 8, the authentication information is printed in alphanumeric form. The authentication information “IA” can all the same be fully or partly printed in the form of a graphic display.

This graphic display is for example the first part “P1” of the authentication information “IA” which is a drawing whose form and/or colour corresponds to a parameter “IT” relative to the validity of the ticket “T”.

According to other embodiments of the invention (not represented), the authentication information “IA” is partly printed according to a printing mode readable by the traffic warden “A”, notably the first part “P1” which is a drawing, and the other part is printed in a form readable by an electronic device. The authentication information “IA” can also be printed several times on the ticket, and according to the different writing modes, rendering any possible forgery complicated.

The described invention notable relates to metered parking for which the payment is made at the time the parking space is being used. However, the invention is not restricted to this modality, and can be applied when the payment is made once the user leaves the parking space.

For this other modality, the end of parking time and the amount paid are not specified during the editing of the ticket “T”. The ticket “T” thus comprises information solely relating to the start of parking, such as the issue time of the ticket “T” and the reference number “NHO” of the parking meter “HO”.

The method therefore has another structure (not represented), thus, the step of editing “EC” the parameters “IT” relative to the validity of the ticket “T” is placed after the step of recording “EIA” the authentication information “IA”.

Moreover, the generating of the authentication information “IA”, notably the first part “P1”, is done according to the start of parking time or date.

Finally, the step of controlling “C” is done at the same time as the step of editing “EC” the characteristics related to the transaction, these two steps can be performed by the same device, whether it be automatic or human.

The information medium was described as being a printed ticket, however it will be understood that the medium can be of another nature such as an electronic box which comprises a display of liquid crystal type.

The ticket “T” was described as being solely used during parking, the start and end of parking times included. The ticket “T” can also be used in the event of claims, the method of checking claims thus comprises the steps of the aforementioned method, notably the step of controlling.

A ticket “T” was described which is used as a parking ticket. However, the invention is not restricted to this use and it can be applied to numerous other ticket systems allowing access to a product or a service such as amusement parks, auditoriums, etc.

The invention therefore allows to reduce the possibility of fraud by printing a code which comprises different parts, and in which each part is specified differently to the others, whilst comprising a part easily identifiable by a ticket inspector.

1. A method for editing tickets providing access to a product or service with specific duration and or expiry date, said method comprising for each ticket, the steps of:
generating a first part of authentication information by encrypting one parameter relative to the validity of the ticket with a key algorithm, wherein said one parameter is printed on the ticket, and wherein said one parameter is selected from the group consisting of the end of parking time, the start of the parking time, the issue date of the ticket, and the validity date of the ticket; and
recording on the ticket the authentication information.

2. A method according to claim 1, further comprising the step of generating a second part of the authentication information which is a unique identification number of the ticket, distinct from the one parameter relative to the validity of the ticket.

3. A method according to claim 1, wherein said key algorithm is modified every predetermined period of time.

4. The method according to claim 3, wherein said key algorithm is modified every fortnight.

5. A method according to claim 1, wherein the key algorithm is modified after a predetermined number of produced tickets.

6. The method according to claim 5 wherein the key algorithm is modified every 1,000 produced tickets.

7. The method according to claim 3, wherein the tickets are produced by a parking meter; and
wherein the key algorithm is modified by reprogramming the parking meter.

8. The method according to claim 5, wherein the tickets are produced by a parking meter; and
wherein the key algorithm is modified by reprogramming the parking meter.

9. The method according to claim 1, wherein the tickets are produced by a parking meter; and
wherein the authentication information comprises a third part, which consists in a signature of the parking meter.

10. The method of claim 9, wherein the third part is specified according to the first part and the second part.

11. The method according to claim 2, wherein the unique identification information is an increment starting from the editing of the previous ticket.

12. The method according to claim 2, wherein the unique identification information is a transaction number specified by an external system of transaction authentication.

13. The method according to claim 1, wherein the first part of the authentication information includes a graphic device whose form and/or color is specific according to the one parameter relative to the validity of the ticket.

14. The method according to claim 1 wherein the recording consists in printing on the ticket.

15. A system for editing tickets, comprising a means for implementing the method according to claim 1.
